(19) United States
(12) Patent Application Publication
(10) Pub. No.: US 2009/0123706 A1
(43) Pub. Date: May 14, 2009

(54) Papermaking Felt

(75) Inventor: Makoto Takahashi, Tokyo (JP)

Correspondence Address: MORGAN LEWIS & BOCKIUS LLP, 1111 PENNSYLVANIA AVENUE NW, WASHINGTON, DC, 20004, US

(73) Assignee: ICHIKAWA CO., LTD., Bunkyo-ku, Tokyo (JP)

(21) Appl. No.: 11/920,630

(22) PCT Filed: Aug. 1, 2006
(86) PCT No.: PCT/JP2006/315564

§ 371 Date: Nov. 19, 2007

(30) Foreign Application Priority Data
Aug. 1, 2005 (JP) 2005-223031

(51) Int. Cl. D21F 7/08; B32B 5/26; D03D 25/00; D21F 3/04; D04H 1/08; B32B 7/02

(52) U.S. Cl. 428/172; 442/326; 442/181; 442/324; 428/213

(57) ABSTRACT

A papermaking felt is provided with a base member, a batt layer formed on the base member, and a protective layer which is formed over a predetermined width in a contacting portion of the papermaking felt where a press roll of a press apparatus comes into contact.

### TECHNICAL FIELD

The present invention relates to a papermaking felt, the felt being used to convey a wet paper web in a paper machine.

### BACKGROUND ART

A paper machine generally includes a wire part, a press part, and a dryer part. The wire part, the press part and the dryer part are arranged in this order, along a conveying direction of a wet paper web. The wet paper web is conveyed by being transferred in succession among papermaking conveying means provided respectively in the wire part, the press part and the dryer part. While the wet paper is conveyed, water is squeezed out therefrom (in other words, water is drained), and finally, the wet paper is dried in the dryer part.

FIG. 4 shows an example of a shoe press apparatus 91 constituting the press part. A shoe S having a concave arc-shaped upper surface is maintained in a planar contact with a lower surface of a press roll P, and a wet paper web W is supplied therebetween, the wet paper web W being sandwiched between a pair of endless papermaking felts 92, 93. Between the shoe S and the papermaking felt 93 on the shoe S side, a press belt B which runs together with the papermaking felt 93 is provided. The shoe S pushes up the press belt B to press the papermaking felts 92, 93 against the press roll P to form a wide nip area, whereby the Water squeeze effect is improved by a planar pressure between the press roll P and the shoe S. In general, the press roll P is provided with tapered parts P′ at both axial end parts thereof as shown in FIG. 5. The tapered parts P′ are formed to be constricted toward outer side. Further, round chamfered parts are generally formed at both ends the shoe S. A nip area N is formed by the planar pressure between the press roll P and the shoe S. FIG. 6 shows another example of a shoe press apparatus 51 having another press part. In the shoe press apparatus 51, a wet paper web W is sandwiched between a pair of endless papermaking felts 92, 93 and supplied between press rolls P, PA. In this case, a nip area N is formed by the pressure of one of the press rolls, and a water squeeze effect is achieved by a linear pressure formed by the press rolls P, PA. As shown in FIG. 6, each of the press rolls P, PA of the shoe press apparatus also has tapered parts P′ that are constricted toward outer side at both axial end parts thereof. In the structures shown in FIGS. 5 and 6, the papermaking felt 92 of the top side may be dispensed with. In such case, when the wet paper web is pressed between the press rolls P, PA, the press roll P of the top side contacts with the wet paper web supporting surface of the bottom papermaking felt 93 across the wet paper web.

In the structures shown in FIGS. 5 and 6, the papermaking felts 92, 93 tend to be abraded at contacting portions where the edges P″ of the press rolls P, PA come in to contact. In general, the papermaking felt 92 or 93 includes a base member of a woven cloth formed by synthetic fibers such as polyamide or natural fibers, and batt layers formed of fiber material which is attached on both sides of the base member by a needle work. In particular, synthetic fibers having satisfactory abrasion resistance, such as polyamide, are often employed as a material for forming the batt layer of a papermaking felt. Although various improvements have been made in the base member and the batt layer in order to improve the characteristics and the performance of the papermaking felt (for example U.S. Pat. No. 4,500,588, JP-A-2001-89990 and JP-A-2004-124274), the problem of abrasion in the contacting portions of the papermaking felt, where the edges P″ of the press roll P, PA come into contact., has not been considered in the related art.

For the purpose of improvement of the productivity, recent papermaking machines have made a significant increase in the production speed, namely a conveying speed of the papermaking felt and the wet paper web. Therefore the aforementioned problem of the abrasion of the papermaking felt, in the contacting portions where the papermaking felt contacts with the press roll, has become conspicuous.

### DISCLOSURE OF THE INVENTION

It is an object of the present invention is to provide a papermaking felt, which is excellent in durability by suppressing an abrasion in a contacting portion of the felt where an edge of the press roll comes into contact.

According to a first aspect of the invention, a papermaking felt includes a base member, a batt layer formed on the base member, and a protective layer which is formed over a predetermined width in a contacting portion of the papermaking felt where a press roll of a press apparatus comes into contact.

According to a second aspect of the invention, as set forth in the first aspect of the invention, the protective layer may include a coated layer of a thermosetting resin.

According to a third aspect of the invention, as set forth in the first aspect of the invention, the protective layer may include a woven cloth or a non-woven cloth adhered to the batt layer.

According to a fourth aspect of the invention, as set forth in the first aspect of the invention, the protective layer may include a woven cloth or a non-woven cloth sewn onto the batt layer.

According to a fifth aspect of the invention, as set forth in the first aspect of the invention, the protective layer may include a core-sheath type composite fiber provided in a surface layer part of the batt layer.

According to a sixth aspect of the invention, as set forth in any of the first to fifth aspects of the invention, an area where the protective layer is formed may be thinner than other areas.

According to a seventh aspect of the invention, as set forth in the sixth aspect of the invention, the area where the protective layer is formed is recessed.

According to an eighth aspect of the invention, as set forth in the sixth aspect of the invention, the area where the protective layer is formed is tapered.

The papermaking felt of the present invention is capable of suppressing the abrasion when contacted with the edge of the press roll, due to a protective layer disposed on a contacting portion where the papermaking felt contacts with a edge of the press roll, thereby significantly extending the service life in comparison with the prior one. Besides, since the protective layer is provided only partially, the invention has a wide applicability and may be exploited with a low cost.

### BRIEF DESCRIPTION OF THE DRAWINGS

FIG. 1 is a cross-sectional view showing an example of a papermaking felt of the present invention.

FIG. 2 is a cross-sectional view showing another example of a papermaking felt of the present invention.

FIG. 3 is a cross-sectional view showing another example of a papermaking felt of the present invention.

FIG. 4 is a schematic view showing an example of a press apparatus of a paper machine.

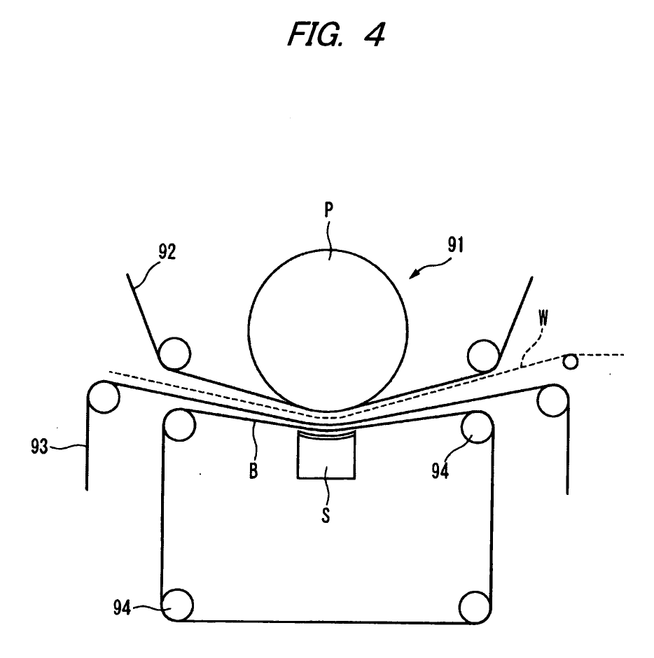

FIG. 5 is a view showing a nip part and a peripheral part thereof in a press apparatus.

FIG. 6 is a view showing a nip part and a peripheral part thereof in another press apparatus.

### DESCRIPTION OF THE EXEMPLARY EMBODIMENTS

Hereinafter, a detailed explanation of the present invention will be described.

In the present invention, there are no particular limitations other than forming a protective layer on a contacting portion of a papermaking felt which contacts with an edge of a press roll. Therefore the papermaking felt, on which the protective layer is to be formed, is not restricted. However, followings are some examples of papermaking felts.

In general, papermaking felts have a base member which is sandwiched between batt layers. Generally, a textile woven from warps and wefts, for example in a weaving machine, is used as a base member. Materials for the warp and weft may be polyester (such as polyethylene terephthalate, or polybutylene terephthalate), polyamide (such as polyamide-6, polyamide-66, polyamide-610 or polyamide-612), polyphenylene sulfide, polyvinylidene fluoride, polypropylene, aramide, polyether ether ketone, polytetrafluoroethylene, polyethylene, polyvinyl chloride, cotton, wool or metal. Also warps and wefts adhered together with an adhesive material without weaving, a non-woven cloth, a film or a resin molded member may also be utilized as a base member.

A batt layer is formed by laminating web-shaped members formed from synthetic fibers such as polyamide fibers or natural fibers such as wool, and is integrated with the base member by a needle work.

It is also possible, if necessary, to apply various treatments or to add a new layer. For example, a hydrophilic non-woven layer or a re-wetting preventing layer may be provided between the base member and the batt layer.

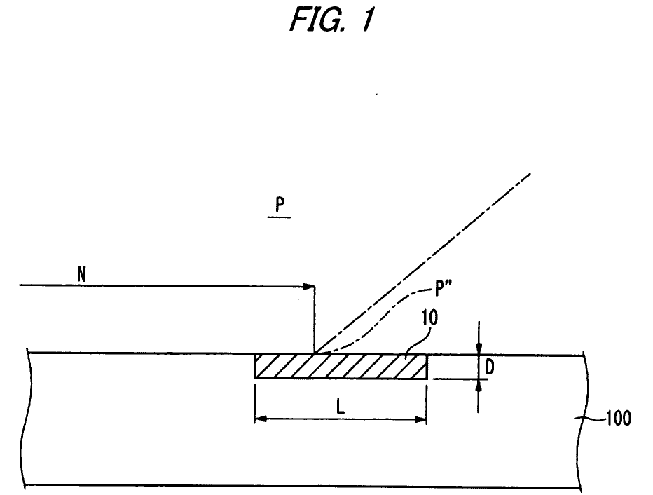

In the present invention, as shown in FIG. 1, a protective layer 10 for providing an abrasion resistance is formed on a contacting portion of a papermaking felt 100, where the papermaking felt 100 contacts with an edge of a press roll. The protective layer 10 may be a coated layer formed by coating and curing a thermosetting resin along an outer edge of a nip area N of the papermaking felt 100 (namely, along an edge P″ of the press roll P) having a predetermined width around the outer edge. The width L of the protective layer 10 is set from 1 cm to 50 cm, preferably from 5 cm to 20 cm, covering an inner side and an outer side of the outer edge of the nip area, in consideration of a certain displacement of the felt in a width direction while the felt circulates in the paper machine. As to the thickness D of the protective layer 10, a larger thickness is advantageous for maintaining the abrasion resistance over a prolonged period but reduces the flexibility and increases the rigidity thereby possibly causing a vibration of the roll in the vertical direction in the vicinity of the edge P″ of press roll P. Therefore, it is preferable that the protective layer 10 be formed so as not to penetrate into the base member. Namely, in consideration of the abrasion resistance and the flexibility (or roll vibration causing by rigidity), the thickness D of the protective layer 10 is set to be equal to or less than the thickness of the batt layer.

The thermosetting resin is not particularly restricted. For example, polyurethane resin, phenolic resin, epoxy resin, melamine resin, urea resin or synthetic rubber may be used. The protective layer 10 is formed by roll coating or spraying an emulsion of such thermosetting resin for impregnation, followed by a curing under heating. In this operation, a coating amount of the emulsion is adjusted so as to obtain the thickness D described above.

Instead of the coated layer, the protective layer 10 may also be formed by adhering or sewing a woven cloth or a non-woven cloth of a stripe shape having the width L described above onto the batt layer. The woven cloth or the non-woven cloth is preferably formed by abrasion resistant fibers, and is preferably a woven cloth or a non-woven cloth made of polyamide. A weight and a fiber fineness of the woven or non-woven cloth is not restricted and are suitably selected in consideration of a type, a hydrophilicity and an abrasion resistance of the fiber. For example, “Conex Cloth CO5121” (cloth of meta-aromatic aramide fibers, warp: yarn number 30, 120 yarns/5 cm, weft: yarn number 30, 120 yarns/5 cm, weight: 96 g/m²) manufactured by Teijin Ltd., and “Conex Cloth CO1910” (cloth of meta-aromatic aramide fibers, warp: twisted two yarns of yarn number 30, 120 yarns/5 cm, weft: twisted two yarns of yarn number 30, 92 yarns/5 cm, weight: 170 g/m²) manufactured by Teijin Ltd. may be employed.

Any adhesive material may be employed without restriction, as long as the woven or non-woven cloth can be adhered to the batt layer. However, it is preferable to sew the woven or non-woven cloth to the batt layer, in consideration of the joining property to the batt layer formed by fibrous material, and in order not to lose the water permeability.

Furthermore, the protective layer 10 may also be formed with a core-sheath type composite fiber disposed on a surface layer part of the batt layer. The core-sheath composite fiber is formed by covering a core component of a resin having a higher melting point with a resin (sheath component) having a lower melting point. The protective layer 10 on the surface layer part of the batt layer can be improved in a durability such as a strength and an abrasion resistance, by heating the entire structure to a temperature higher than the melting point of the resin having the lower melting point but lower than that of the resin having the higher melting point, thereby fusing the sheath component and forming a network structure of the sheath component between the fibers. For the papermaking felt, a core-sheath composite fiber formed with a polyamide resin having an excellent abrasion resistance is preferable. For example, a core-sheath composite fiber utilizing polyamide-6 as the core component and a copolymerized polyamide as the sheath component, or a core-sheath composite fiber utilizing polyamide-66 as the core component and polyamide-6 as the sheath component may be employed.

The protective layer 10 of such core-sheath composite fiber may be formed according to an ordinary method for forming a batt layer by a needle work. More specifically, after a batt layer is formed by a needle work on the base member, core-sheath composite fibers are laid down with predetermined width and thickness in an area where the protective layer 10 is to be formed while fibers for forming an ordinary batt layer are laid down in other areas, and a needle work is executed on the entire area. The width and the thickness of the protective layer 10 are similar to that in the case of a coated layer. A fill rate (basis weight) of the core-sheath composite fibers may be same as that of the batt layer in other areas. However, the is fill rate (basis weight) of the core-sheath composite fibers may be higher than that of the batt layer in order to maintain the abrasion resistance over a prolonged period.

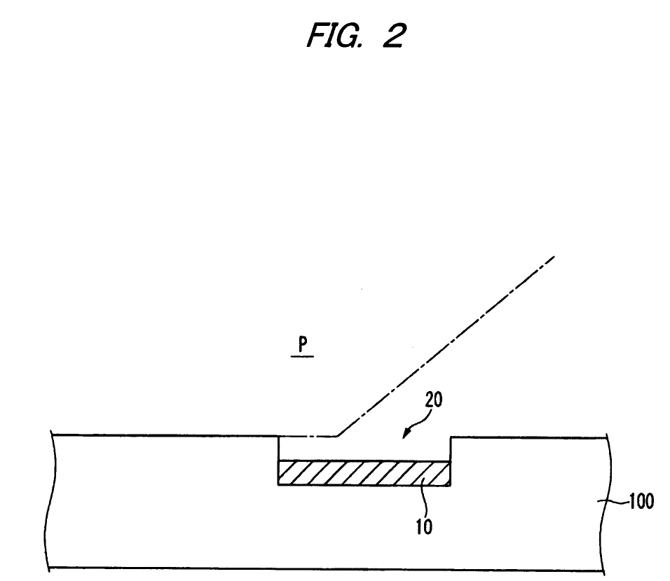

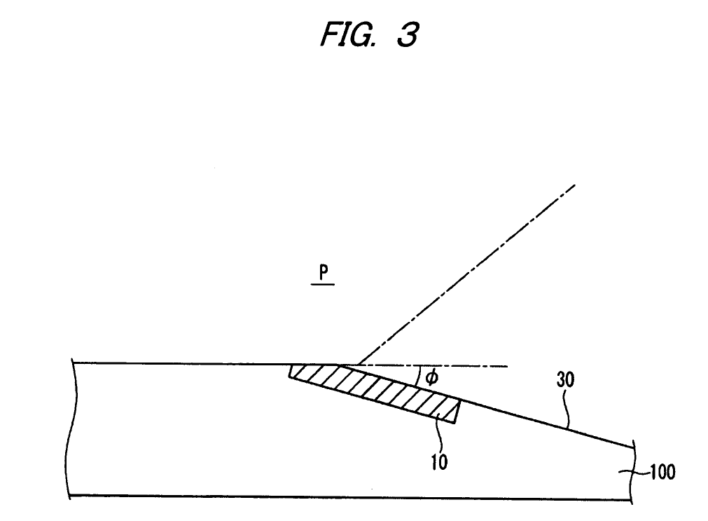

Also, as shown in FIGS. 2 and 3, the papermaking felt 100 may be made thinner at an area where the protective layer 10 is formed. FIG. 2 shows an example in which a recess portion 20 is formed over the entire width of the protective layer 10. FIG. 3 shows another example in which the papermaking felt 100 has, a tapered surface 30, the thickness of which gradually decreasing from a point where the protective layer 10 is formed toward the outer end of the papermaking felt. For obtaining a thinner protective layer 10, a method of forming the protective layer 10 and then compressing it by a thermal pressing is convenient, efficient and secure. An extent of such thinner structure is preferably, in the case of a recess 20 as shown in FIG. 2, a step difference of from 0.5 mm to 3.0 mm from the surface of the batt layer to the surface of the protective layer 10, and in the case of a tapered surface 30 as shown in FIG. 3, a tapered angle φ within a range of from 0.5° to 3.0°. Also in the case of forming a tapered surface 30 as shown in FIG. 3, it is also possible to form a structure, though not illustrated, having a tapered surface only in the protective layer 10 and other area outside the protective layer 10 having a flat surface with a constant thickness.

By forming the area of the protective layer 10 thinner, the edge P″ of the press roller P no longer contacts the protective layer 10, or has a smaller pressure in case of contact, thereby further suppressing the abrasion of the protective layer 10.

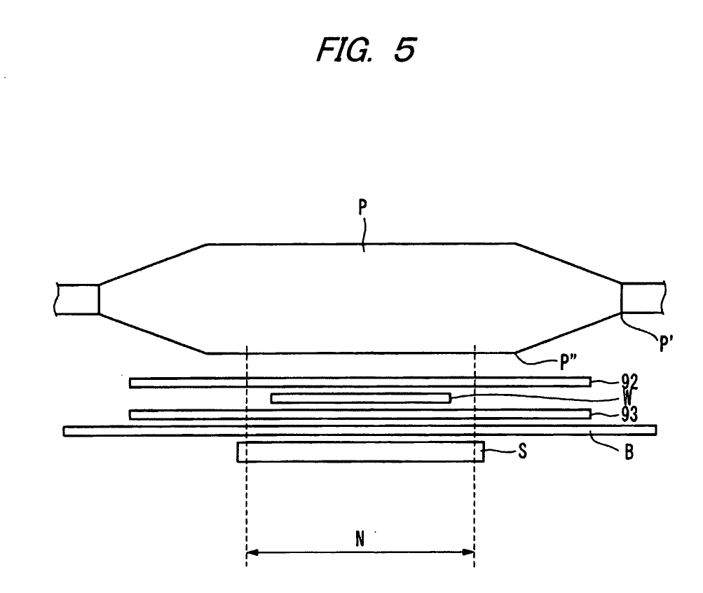

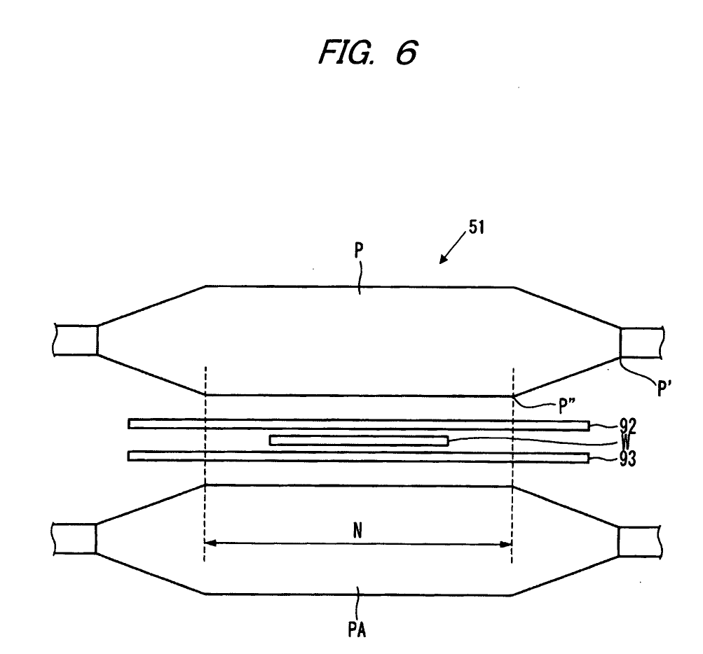

The papermaking felt of the present invention is not limited to the aforementioned embodiments but is subject to various modifications. For example, although the protective layer 10 is formed only on a side of the felt which contacts with the press roller, a similar protective layer may also be formed on the opposite side of the felt, that is the side that does not contact the press roller. In another example, when the papermaking felt 92 of the top side is dispensed with in the structures shown in FIGS. 5 and 6, a wet paper web supporting side of the papermaking felt 93 of the bottom side contacts with the press roller, so that the protective layer 10 is provided on the wet paper web supporting side of the felt. Thus the felt is balanced in the running state between the top and rear surfaces, while conveying the wet paper web.

While there has been described in connection with the exemplary embodiments of the present invention, it will be obvious to those skilled in the art that various changes and modification may be made therein without departing from the present invention. It is aimed, therefore, to cover in the appended claim all such changes and modifications as fall within the true spirit and scope of the present invention.

The present invention claims foreign priority from Japanese patent application no. 2005-223031, filed on Aug. 1, 2006, the content of which is incorporated herein by reference.

### INDUSTRIAL APPLICABILITY

As described above, the papermaking felt according to the present invention has an excellent abrasion resistance in the contacting portion of thereof which contacts with the edge of the press roller. Therefore, it is suitable for use in a paper machine having a high speed and a high pressure.

1. A papermaking felt comprising:
a base member;
a batt layer formed on the base member; and
a protective layer which is formed over a predetermined width in a contacting portion of the papermaking felt where a press roll of a press apparatus comes into contact.

2. The papermaking felt according to claim 1, wherein the protective layer includes a coated layer of a thermosetting resin.

3. The papermaking felt according to claim 1, wherein the protective layer includes a woven cloth or a non-woven cloth adhered to the batt layer.

4. The papermaking felt according to claim 1, wherein the protective layer includes a woven cloth or a non-woven cloth sewn onto the batt layer.

5. The papermaking felt according to claim 1, wherein the protective layer includes a core-sheath type composite fiber provided in a surface layer part of the batt layer.

6. The papermaking felt according to claim 1, wherein an area where the protective layer is formed is thinner than other areas.

7. The papermaking felt according to claim 6, wherein the area where the protective layer is formed is recessed.

8. The papermaking felt according to claim 6, wherein the area where the protective layer is formed is tapered.

9. The papermaking felt according to claim 2, wherein an area where the protective layer is formed is thinner than other areas.

10. The papermaking felt according to claim 3, wherein an area where the protective layer is formed is thinner than other areas.

11. The papermaking felt according to claim 4, wherein an area where the protective layer is formed is thinner than other areas.

12. The papermaking felt according to claim 5, wherein an area where the protective layer is formed is thinner than other areas.
